(19) United States
(12) Patent Application Publication
(10) Pub. No.: US 2021/0314727 A1
(43) Pub. Date: Oct. 7, 2021

(54) SOCIAL DISTANCING DEVICE, SYSTEM, AND METHOD

(71) Applicant: E2E, Mfg. LLC, Pleasanton, CA (US)

(72) Inventors: Gioni BIANCHINI, Los Altos, CA (US); Iggoni FAJARDO, Fremont, CA (US)

(21) Appl. No.: 16/925,025

(22) Filed: Jul. 9, 2020

Related U.S. Application Data
(60) Provisional application No. 63/003,467, filed on Apr. 1, 2020.

(51) Int. Cl. H04W 4/02; G08B 7/06; G08B 21/18

(52) U.S. Cl. CPC H04W 4/023; H04B 17/318; G08B 21/182; G08B 7/06

(57) ABSTRACT

The present invention discloses a social distancing device system including a first social distancing device and a computing device. The first social distancing device includes a distance detecting module configured to detect a distance between the first social distancing device and a second social distancing device, a process configured to record a time information and a duration of contacting when the distance detected by the distance detecting module is less than a predetermined distance, and a transmission module configured to transmit a signal including the time information and the duration of contacting. The computing device includes a database configured to store the time information and the duration of contacting and a computing module configured to calculate an exposure risk of the first social distancing device according to the time information and the duration of contacting.

### BACKGROUND OF THE INVENTION

### 1. Field of the Invention

The present invention relates to a social distancing device system, and more particularly, to a social distancing device system for detecting the social distance and calculating the exposure risk for infectious diseases.

### 2. Description of the Prior Art

Infectious diseases are medically proven and caused by the presence or activity of pathogenic microorganisms, and harm the infected person or damage the physiological functions of humans or other species. Infectious diseases are communicable diseases that can be transmitted from one person or other species to another through various means. Moreover, the infection diseases spreading through air or through droplets, such as the measle, the pertussis, the pulmonary tuberculosis, H5N1, H7N9, H1N1, MERS-CoV, or COVID-19, would spread rapidly. These infections are mostly caused by the mouth, the nasal mucosa or the respiratory duct contacting the infected substances.

Because the infectious diseases spreading by air or droplets have a certain spreading distance, the social distancing or physical distancing is a non-pharmaceutical infection control action intended to avoid the direct contact of the infected substance and stop or slow down the spread of a infectious disease. For example, one should keep a certain distance (typically 3 feet or 1 meter) from the others, or be socially isolated to reduce the infectivity.

In general, some infectious diseases have an incubation period. The infected person may not have disease symptoms or discomfort during the incubation period, so that the infected person may still participate in social activities and do not maintain a certain distance from others. However, infectious diseases in infected person still have the infectivity during the incubation period. For other people who have been contacted with the infected person, they may be infected as well and contact with more others because it is not easy to know that the infected person has been infected during the incubation period. Therefore, when an infected person during the incubation period frequently joins in social activities, it is difficult to track other people who have been in contact with the infected person and to control the spread of infectious diseases.

Thus, it is necessary to develop a new social distancing device that can maintain an appropriate social distance and manage the users at risk of infection to solve the problems of the prior art.

### SUMMARY OF THE INVENTION

Therefore, one of categories of the present invention is to provide a social distancing device system including a first social distancing device and a computing device. The first distancing device includes a distance detecting module, a processor and a transmission module. The distance detecting module is configured to detect a distance between the first social distancing device and a second social distancing device. The processor is coupled to the distance detecting module and configured to record a time information and a duration when the first social distancing device communicates with the second social distancing device. The transmission module is coupled to the processor and controlled by the processor to transmit a signal including the distance, the time information and the duration. The computing device is configured to receive the distance, the time information and the duration from the transmission module and includes a database and a computing module. The database is configured to store the distance, the time information and the duration. The computing module is coupled to the database to calculate an exposure risk of the first social distancing device according to the distance, the time information and the duration.

Wherein, the distance detecting module includes at least one wireless signal transceiver for communicating with the distance detecting module in the second social distancing device and detecting the distance by signal strength.

Furthermore, the at least one wireless signal transceiver is one selected from Wi-Fi transceiver, Bluetooth transceiver, NFC transceiver and UWB transceiver.

Wherein, the distance detecting module is a GPS module for detecting the distance between the first social distancing device and the second social distancing device by GPS locating.

Wherein, the first social distancing device further includes an alarm module to generate a first alarm signal when the distance detected by the distance detecting module is less than a predetermined distance.

Furthermore, the predetermined distance is six feet.

Wherein, the computing device sends a second alarm signal to the first social distancing device according to the exposure risk calculated by the computing processor.

Wherein, the database is configured to store a data of the user of the second social distancing device. The computing module calculates the exposure risk according to the distance, the time information, the duration and the data of the user of the second social distancing device.

Furthermore, the computing device further includes a learning module coupled to the database and the computing module. The learning module generates an exposure risk model according to the distance, the time information, the duration and the data stored in the database by machine learning. The computing module analyzes the distance, the time information, the duration and the data by the exposure risk model to generate the exposure risk.

Another one of categories of the present invention is to provide a social distancing device including a first distance detecting module, a second distance detecting module, a processor and a transmission module. The first distance detecting module is configured to communicate with another social distancing device in an area with a radius. The second distance detecting device is configured to detect a distance between the social distancing device and the another social distancing device. The processor is coupled to the first distance detecting module and the second distance detecting module and configured to record a time information and a duration when the first social distancing device communicates with the another social distancing device. The transmission module is coupled to the processor and controlled by the processor to transmit a signal of the distance, the time information and the duration to a server. Wherein, the processor controls the second detecting module to detect the distance after the first distance detecting communicates with the another social distancing device.

Wherein, the second distance detecting module is configured to send and receive a data packet. The second distance detecting module sends the data packet to the another social distancing device and receives the data packet calculated by the another social distancing device to detect the distance.

Wherein, the social distancing device further includes an alarm module to generate a first alarm signal when the distance detected by the another distance detecting module is less than a predetermined distance.

Another one of categories of the present invention is to provide a social distancing method including the following steps of: a first social distancing device communicating with a second social distancing device; the first social distancing device detecting a distance between itself and the second social distancing device, and recording a time information and a duration; the first social distancing device sending the distance, the time information and a duration to a computing device; and the computing device calculating an exposure risk of the first social distancing device according to the distance, the time information and a duration.

Wherein, the step of the first social distancing device communicating with the second social distancing device further includes the following steps of: the first social distancing device searching another social distancing device in an area with a radius; and the first social distancing device communicating with the second social distancing device when the second social distancing device is located in the area.

Wherein, the method further includes the following step of: the first social distancing device generating a first alarm signal when the distance is less than a predetermined distance.

Wherein, the step of the computing device calculating an exposure risk of the first social distancing device according to the distance, the time information and a duration further includes the following step of: the computing device calculating the exposure risk of the first social distancing device according to the distance, the time information, the duration and a data of the user of the second social distancing device stored in a database.

Wherein, the step of the computing device calculating an exposure risk of the first social distancing device according to the distance, the time information and the duration further includes the following steps of: generating an exposure risk model according to the distance, the time information, the duration and a data stored of the user of the second social distancing device stored in a database by machine learning; and the computing module analyzing the distance, the time information, the duration and the data by the exposure risk model to generate the exposure risk.

Wherein, the method further includes the following step of: the computing device sending a second alarm signal according to the exposure risk.

Wherein, the step of the first social distancing device detecting a distance between itself and the second social distancing device, and recording a time information and a duration further includes the following step of: the first social distancing device sending a data packet to the second social distancing device and receives the data packet calculated by the second social distancing device to detect the distance, and recording the time information and the duration.

In summary, the social distancing device system can remind the user to maintain the social distance by the alarm module of the social distancing device, and calculate the exposure risk of the user according to the data sent by the social distancing device, thereby increasing the efficiency and reducing the infectivity. Moreover, the social distancing device system can calculate the exposure risk immediately and precisely by the learning module, thereby increasing the efficiency. In addition, the social distancing device system can switch the distance detecting modules to save the power and detect the distance precisely, thereby increasing the deficiency and reducing the cost.

### BRIEF DESCRIPTION OF THE APPENDED DRAWINGS

FIG. 1 is a schematic diagram illustrating a social distancing device system according to an embodiment of the present invention.

FIG. 2 is a functional block diagram illustrating the social distancing device system in FIG. 1.

FIG. 3 is a functional block diagram illustrating the first social distancing device and the second social distancing device in FIG. 2.

FIG. 4 is a functional block diagram illustrating the first social distancing device and the second social distancing device according to another embodiment of the present invention.

FIG. 5 is a schematic diagram illustrating the social distancing devices according to the embodiment of FIG. 4.

FIG. 6 is a functional block diagram illustrating the social distancing device system according to another embodiment of the present invention.

FIG. 7 is a flow diagram illustrating a social distancing method according to an embodiment of the present invention.

FIG. 8 is a flow diagram illustrating the social distancing method according to another embodiment of the present invention.

FIG. 9 is a flow diagram illustrating the social distancing method according to another embodiment of the present invention.

FIG. 10 is a flow diagram illustrating the social distancing method according to another embodiment of the present invention.

FIG. 11 is a flow diagram illustrating the social distancing method according to another embodiment of the present invention.

FIG. 12 is a flow diagram illustrating the social distancing method according to another embodiment of the present invention.

FIG. 13 is a flow diagram illustrating the social distancing method according to another embodiment of the present invention.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

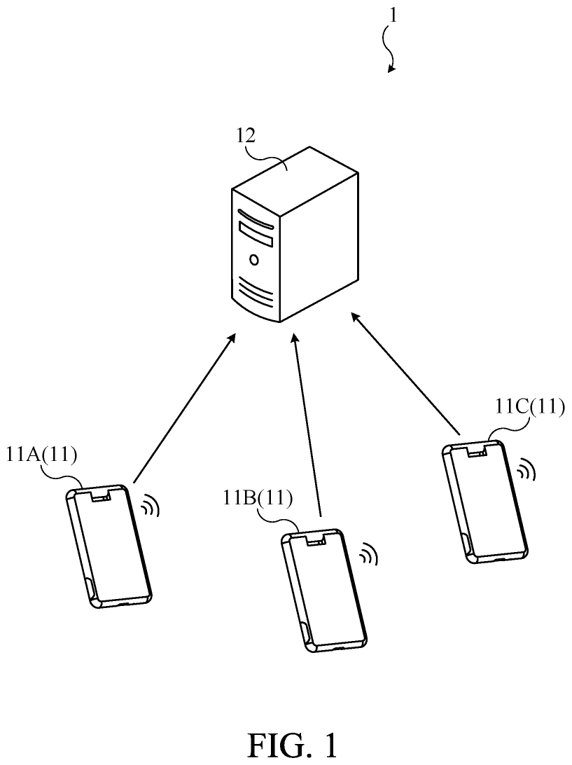

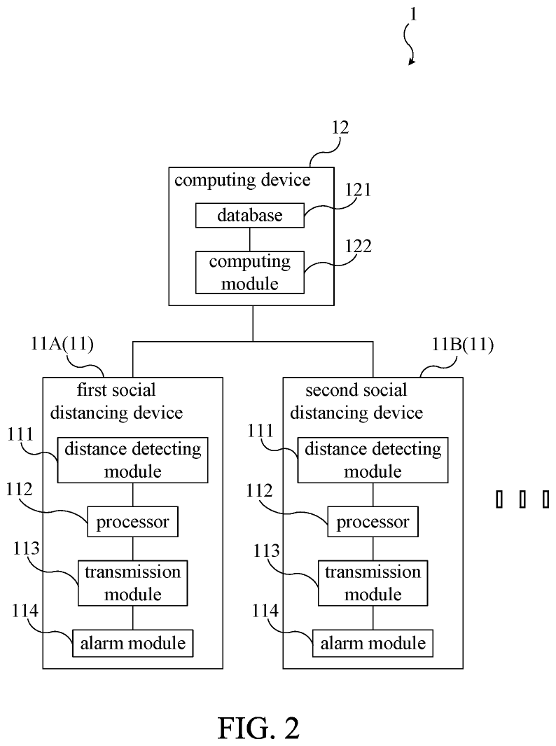

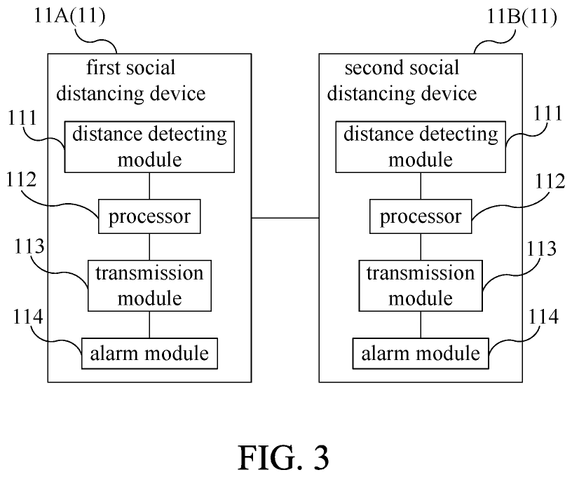

Please refer to FIG. 1, FIG. 2 and FIG. 3. FIG. 1 is a schematic diagram illustrating a social distancing device system 1 according to an embodiment of the present invention. FIG. 2 is a functional block diagram illustrating the social distancing device system 1 in FIG. 1. FIG. 3 is a functional block diagram illustrating the first social distancing device 11A and the second social distancing device 11B in FIG. 2. In this embodiment, the social distancing device system 1 includes a social distancing device 11A and a computing device 12 connected with the social distancing device 11A. Furthermore, the social distancing device system 1 can include a plurality of social distancing devices, and the computing device 12 can connected with the other social distancing devices, which having the same functions with the social distancing device 11A. The social distancing device 11 includes a distance detecting module 111, a processor 112 and a transmission module 113. The distance detecting module 111 is configured to detect a distance between the social distancing device 11 and another social distancing device. The processor 112 is coupled to the distance detecting module 111 and configured to record a time information and a duration when the first social distancing device 11A communicates with the second social distancing device 11B. The transmission module 113 is coupled to the processor 112 and controlled by the processor 112 to transmit a signal including the distance, the time information and the duration to the computing device 12. In practice, the number of social distancing device of the social distancing device system in FIG. 1 and FIG. 2 is not limit to two or three, the number of social distancing device can be more than three. Furthermore, the second social distancing device can be any one social distancing device different from the first social distancing device. Each of social distancing devices can communicate with the computing device 12 respectively, and each of social distancing devices can communicate with the others.

In practice, the social distancing device 11 can be an independent device or a portable device with an application program installed therein. For example, the portable device can be a smart cell phone, a smart watch, a smart ring, or any other wearable smart product. The application program is capable of controlling the portable device to execute the same functions of the social distancing device above-mentioned. The computing device 12 can be a server, computer or mobile devices. The processor 112 can be a CPU, and the transmission module 113 can be a signal transceiver. The time information can be a date or timestamp, and duration is a time length of the communication between the social distancing devices. When the user wears the social distancing device 11, the distance detecting module 111 of the social distancing device 11 can detect the distance between the user and another user who wears or uses another social distancing device. When the user communicates with another user, the transmission module 113 can transmit the distance detected by the distance detecting module 111 and the time information and the duration record by the process 112 to the computing device 12. The functions of the database 121 and the computing module 122 will be described later.

In this embodiment, the distance detecting module 111 of the first social distancing device 11A comprises a wireless signal transceiver for communicating with the distance detecting module 111 of the second social distancing device 11B and detecting the distance. In practice, the distance detecting module 111 can be a Wi-Fi transceiver, Bluetooth transceiver, NFC transceiver or UWB transceiver, and the distance detecting module 111 can detect the distance by signal strength. In practice, when the first social distancing device 11A communicates with the second social distancing device 11B, the distance detecting module 111 of the second social distancing device 11B can send a signal to the first social distancing device 11A, and the distance detecting module 111 of the first social distancing device 11A can calculate the distance according to the attenuation of the signal strength sent by the distance detecting module 111 of the second social distancing device 11B.

In one embodiment, the distance detecting module 111 can be a GPS module. In practice, the distance detecting module 111 of the first social distancing device 11A records a first GPS coordinate of the first social distancing device 11A, and the distance detecting module 111 of the second social distancing device 11B records a second GPS coordinate of the second social distancing device 11B. The second social distancing device 11B sends the second GPS coordinate to the first social distancing device 11A, and then the distance detecting module 111 of the first social distancing device 11A calculates the distance according to the first GPS coordinate and second GPS coordinate. In another one embodiment, the distance detecting module 111 can be a Real-Time Location System (RTLS).

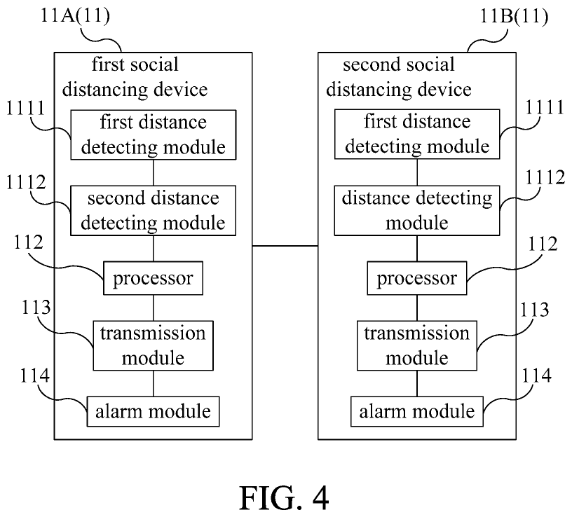

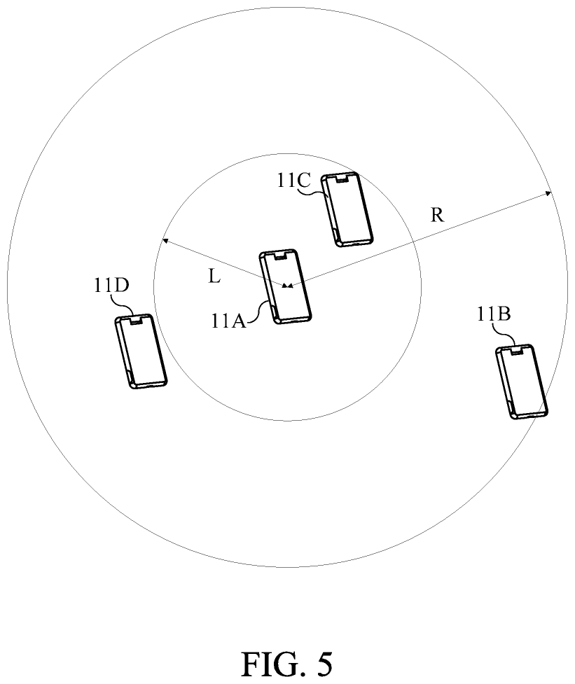

Please refer to FIG. 4 and FIG. 5. FIG. 4 is a functional block diagram illustrating the first social distancing device 11A and the second social distancing device 11B according to another embodiment of the present invention. FIG. 5 is a schematic diagram illustrating the social distancing devices according to the embodiment of FIG. 4. In this embodiment, the first social distancing device 11A and the second social distancing device 11B include a first distance detecting module 1111 and a second distance detecting module 1112 respectively. The first detecting module 1111 is configured to communicate with the first detecting module 1111 of another social distancing device in a circular area with a radius R, and the second distance detecting module 1112 is configured to detect the distance between itself and the second distance detecting module of another social distancing device.

In practice, the first distance detecting module 1111 can be Bluetooth transceiver and the second distance detecting module 1112 can be UWB transceiver. The radius R can be pre-set in the first distance detecting module 1111. As shown in FIG. 5, the first distance detecting module 1111 of the first social distancing device 11A sends a communicating signal in a circular area with radius R to search if another social distancing device enters the circular area. When the second social distancing device 11B enters the circular area, the first distance detecting module 1111 of the second social distancing device 11B receives the communicating signal and sends the response of the communicating signal to the first social distancing device 11A, so that the first social distancing device 11A communicates with the second social distancing device 11B.

Furthermore, the second distance detecting module 1112 of the first social distancing device 11A sends a data packet to the second social distancing device 11B. In practice, the data packet can be a time data, such as sending time and receiving time. After the first social distancing device 11A communicates with the second social distancing device 11B, the second distance detecting module 1112 of the first social distancing device 11A sends a data packet to the second social distancing device 11B and receives the data packet calculated by the second distance detecting module 1112 of the second social distancing device 11B to detect the distance. In one embodiment, the second distance detecting module 1112 of the first social distancing device 11A sends a data packet to the second social distancing device 11B and receives the response of the data packet sent by the second distance detecting module 1112 of the second social distancing device 11B. Then, the second distance detecting module 1112 of the first social distancing device 11A calculates the distance according to the time difference of sending and receiving the data packet.

Moreover, the first distance detecting module 1111 and the second distance detecting module 1112 can be controlled by the processor 112. The second distance detecting module 1112 can send the data packet in certain period such as once per two seconds to update the distance. Because the Bluetooth transceiver is good at proximity sensing but poor for detecting distance, and the UWB transceiver is good at detecting distance, the social distancing device system can switch the Bluetooth transceiver and UWB transceiver to save the power and detect the distance precisely, thereby increasing the deficiency and reducing the cost. In one embodiment, the first distance detecting module 1111 and the second distance detecting module 1112 can be integrated in a signal transmitting chip.

Please refer to FIG. 2 and FIG. 5. The social distancing device 11 further includes an alarm module 114. The alarm module 114 generates an alarm signal when the distance detected by the distance detecting module is less than a predetermined distance L. In practice, the alarm module 114 can coupled to the distance detecting module 111, and the alarm module 114 can be a LED, vibrator or buzzer. The predetermined distance L can be preset in the processor 112. In one embodiment, the predetermined distance is, but not limited to, six feet. The predetermined distance also can be one, two, three, four, five or more than six feet. Furthermore, the unit of the predetermined distance can be inch, centimeter or meter. As shown in FIG. 5, the distance between the first social distancing device 11A and the third social distancing device 11C is less than the predetermined distance L. That is to say, the third social distancing device 11C is located at the circular area with radius L. Then, the processor 112 of the first social distancing device 11A controls the alarm module 114 to generate the alarm signal to remind the user that the user is too close to the third social distancing device 11C. Therefore, social distancing device can remind the user to keep an appropriate distance with others to reduce the infectivity.

In this embodiment, the computing device 12 is configured to receive the distance, the time information and the duration sent by the transmission module 113. The database 121 is configured to store the distance, the time information and the duration. The computing module 122 is coupled to the database 121 to calculate an exposure risk of the first social distancing device according to the distance, the time information and the duration. In practice, the database 121 can store all of the distances, time information and duration of the social distancing devices. The distance, the time information and duration are the risk factors of the exposure risk. The computing module 122 can calculate the exposure risk of each of social distancing devices respectively according to the data stored in the database 121. In one embodiment, the exposure risk can be calculated by the addition of cumulative risk scores of all risk factors. Furthermore, the computing module 122 can be pre-stored a risk threshold value. When exposure risk is greater than the risk threshold, the computing module 122 sends an alarm signal to social distancing device 11.

In this embodiment, the risk score is increased when the distance between the users is shorter. As shown in FIG. 5, the distance between the first social distancing device 11A and the third social distancing device 11C is shorter than that between the first social distancing device 11A and the second social distancing device 11B, so that the risk score of the third social distancing device 11C is greater than that of the second social distancing device 11B. In practice, some infectious diseases have a certain spreading distance. If the user of the first social distancing device 11A is an infector, the infection rate of the user of the third social distancing device 11C is greater than that of the user of the second social distancing device 11B. Similarly, the risk score is increased when the duration between the users is longer. In practice, the infected person may generate the infectious virus in surrounding air, so that the probability of another people which inhaling the infectious virus will also be increased with long duration. Moreover, the risk score can be calculated by the distance and duration. In one embodiment, the duration includes a duration of contacting, and the risk score increasing rate of the duration of contacting is greater than that of the duration. As shown in FIG. 5, although the duration between the first social distancing device 11A and the forth social distancing device 11D and the first social distancing device 11A and the second social distancing device 11B are the same, the risk score of duration of contacting of the forth social distancing device 11D is greater than that of the duration of the second social distancing device 11B. Because the distance between the first social distancing device 11A and the forth social distancing device 11D is shorter than that between the first social distancing device 11A and the second social distancing device 11B, the weighted risk score of the duration of contacting is greater than that of the duration. Therefore, the social distancing device system can track the risk of each of users and remind the users if they are in the high-risk environment to increase efficiency and safety.

In addition, the database 121 can update and store a personal data of the user from other server (such as medical database of government). The personal data can be basic information (such as age, gender) or medical information (such as physical condition, disease history) of the user. Similarly, the data of the user also can be the risk factor. In practice, if the user is an elder with poor body resistance, the infection rate of the user is increased, that is to say, the risk score is increased. Furthermore, when the database 121 updates the data of the user and data includes the user infected information, then the computing module 122 sends the alarm signal to the social distancing device which communicating with social distancing device of the infected user. Furthermore, when incubation period of the disease which the user infected is five days, the computing module 122 sends the alarm signal to the social distancing device according to the time information.

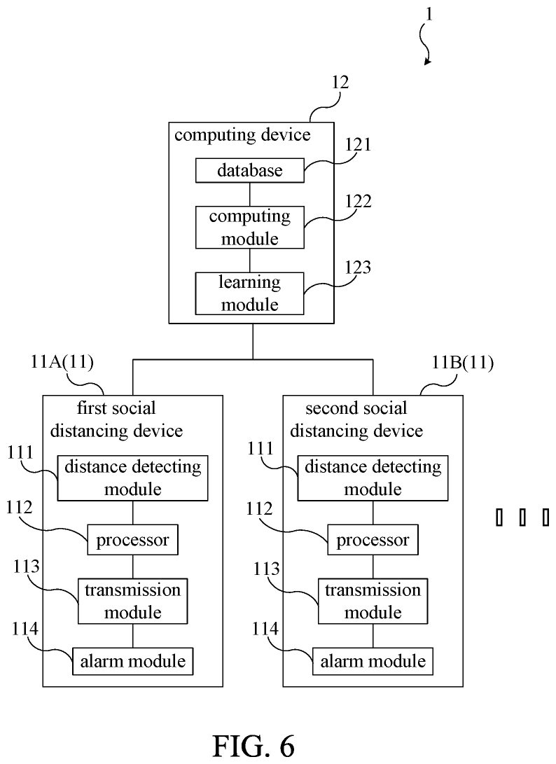

Please refer to FIG. 6. FIG. 6 is a functional block diagram illustrating the social distancing device system 1 according to another embodiment of the present invention. In this embodiment, the computing device 12 further includes a learning module 123 coupled to the database 121 and the computing module 122. The learning module 123 generates an exposure risk model according to the history data of the distance, the time information, the duration and the data stored in the database 121 by machine learning. The computing module 122 analyzes the time information, the duration and the data by the exposure risk model to generate the exposure risk. In practice, the database 121 not only stores the data sent from the social distancing device, but also stores the user's data from other servers. That is to say, the database 121 stores a great amount of information of the social distancing device. The learning module 123 can generate the exposure risk model by algorithm according to the data stored in the database. When the computing device 12 receive a new time information, duration, the distance and the database 121 update the data of users, the computing module 122 generates the exposure risk and stores those data and the exposure risk as the history data to the database 121. Then, the learning module 123 can renew the exposure risk model according to the data stored in the database 121. Therefore, the social distancing device system can track and remind the user immediately and precisely to reduce the infectivity and increase detection efficiency.

In one embodiment, the social distancing device further includes a rechargeable battery (not shown in figure). The rechargeable battery is configured to provide power to the social distancing device and can coupled to the processor. When the social distancing device is recharging, the processor controls the transmission module to send the data to the computing device 12.

The social distancing device system of the present invention can apply to various places, such as office, school, hospital and so on. When the social distancing device system applies to the office, one of the social distancing devices can be set at the meeting room, and all of employees wear others social distancing devices respectively. The predetermined distance can be pre-set according to the size of the meeting room. Therefore, the administrator can confirm the number of employees in the meeting room and check the employees who in the meeting room by the mounted social distancing device. If the employee who had been to the meeting room is infected, the administrator can quickly and easily to remind the other employees.

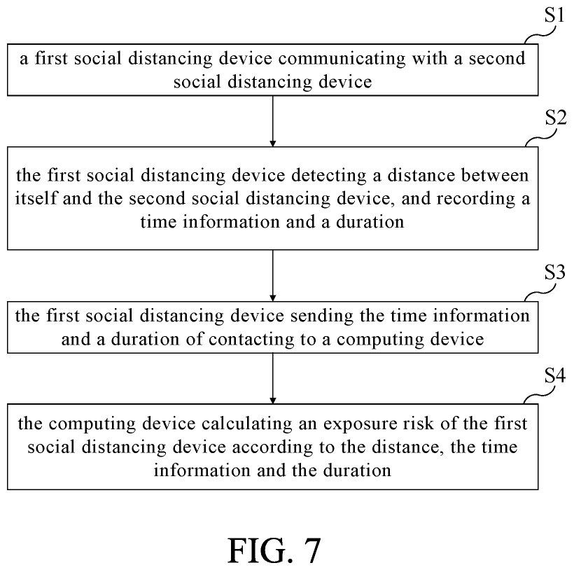

Please refer to FIG. 7. FIG. 7 is a flow diagram illustrating a social distancing method according to an embodiment of the present invention. In this embodiment, the social distancing method can be executed by the social distancing device system of FIG. 2. As shown in FIG. 7, the social distancing method includes the following steps: in the step S1, a first social distancing device 11A communicating with a second social distancing device 11B; in the step S2, the distance detecting module 111 of first social distancing device 11A detecting a distance between itself and the second social distancing device 11B, and the processor 112 of first social distancing device 11A recording a time information and a duration when the first social distancing device 11A communicates with the second social distancing device 11B; in the step S3, the transmission module 113 of the first social distancing device 11A sending the distance, the time information and the duration to a computing device 12; and in the step S4, the computing device 12 calculating an exposure risk of the first social distancing device 11A according to the distance, the time information and a duration. In practice, the method is not limited to two social distancing devices. The second social distancing device can be any one social distancing device different from the first social distancing device. The computing device can calculate the exposure risk of each of social distancing devices.

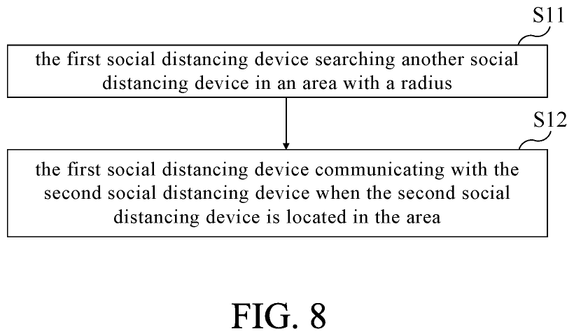

Please refer to FIG. 8. FIG. 8 is a flow diagram illustrating the social distancing method according to another embodiment of the present invention. In this embodiment, the social distancing method can be executed by the social distancing device system of FIG. 4. In this embodiment, the step S1 of FIG. 7 further includes the following steps: in the step S11, the first distance detecting module 1111 of the first social distancing device 11A searching another social distancing device 11B in an area with a radius; and the first distance detecting module 1111 of the first social distancing device 11A communicating with the first distance detecting module 1111 of the second social distancing device 11B when the second social distancing device 11B is located in the area.

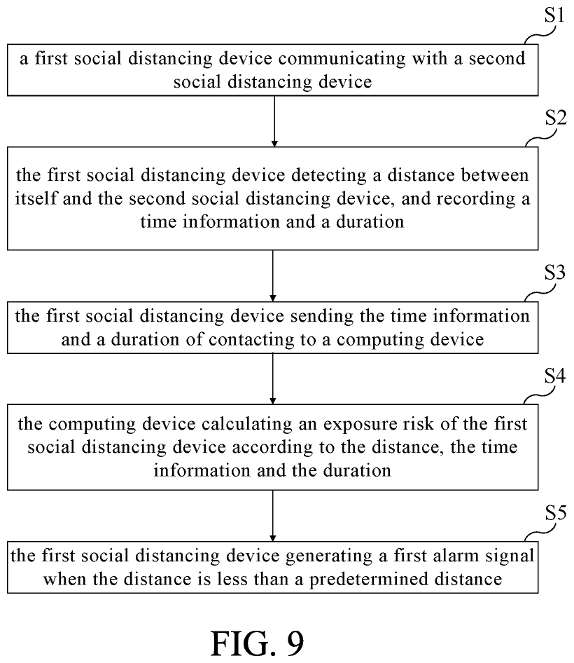

Please refer to FIG. 9. FIG. 9 is a flow diagram illustrating the social distancing method according to another embodiment of the present invention. In this embodiment, the steps of FIG. 7 further include the following step: in the step S5, the first social distancing device 11A generating a first alarm signal when the distance is less than a predetermined distance.

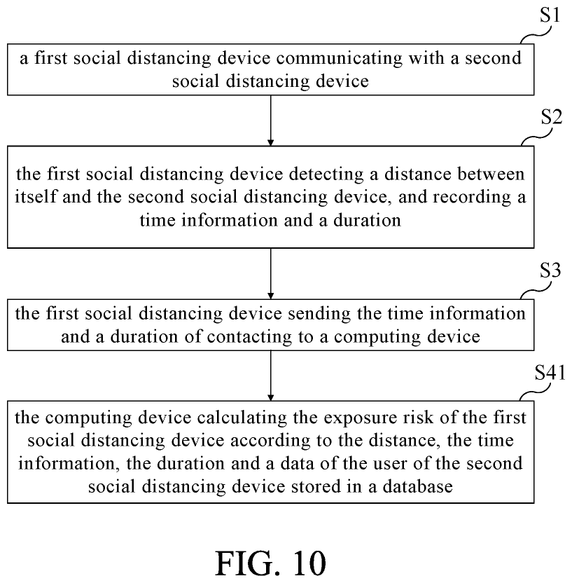

Please refer to FIG. 10. FIG. 10 is a flow diagram illustrating the social distancing method according to another embodiment of the present invention. In this embodiment, the step S4 of FIG. 7 further includes the following steps: in the step S41, computing module 122 of the computing device 12 calculating the exposure risk of the first social distancing device 11A according to the distance, the time information, duration and a data of the user of the second social distancing device 11B stored in a database 121.

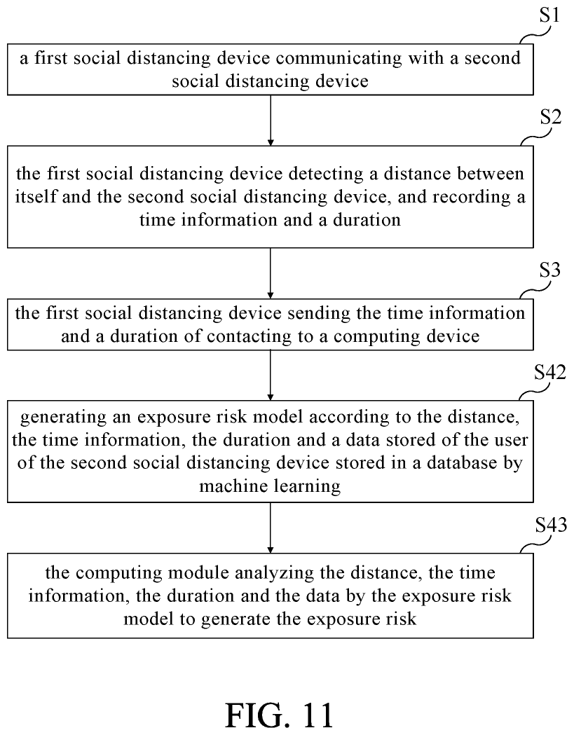

Please refer to FIG. 11. FIG. 11 is a flow diagram illustrating the social distancing method according to another embodiment of the present invention. In this embodiment, the social distancing method can be executed by the social distancing device system of FIG. 6. The step S4 of FIG. 7 further includes the following steps: in the step S42, the learning module 123 generating an exposure risk model according to the distance, the time information, the duration and a data stored of the user of the second social distancing device stored in a database 121 by machine learning; and in the step S43, the computing module 122 analyzing the time information, the duration and the data by the exposure risk model to generate the exposure risk.

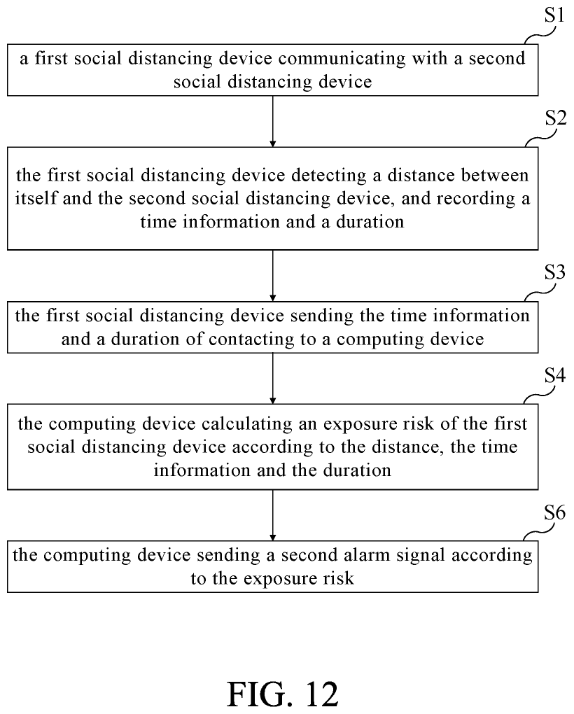

Please refer to FIG. 12. FIG. 12 is a flow diagram illustrating the social distancing method according to another embodiment of the present invention. In this embodiment, the steps of FIG. 7 further include the following step: the computing device 12 sending a second alarm signal to the first social distancing device 11A according to the exposure risk.

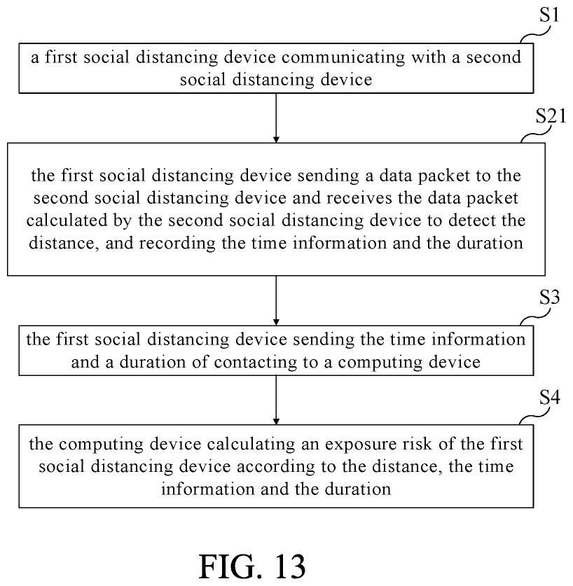

Please refer to FIG. 13. FIG. 13 is a flow diagram illustrating the social distancing method according to another embodiment of the present invention. In this embodiment, the social distancing method can be executed by the social distancing device system of FIG. 4. The step S2 of FIG. 7 further includes the following step: in the step S21, the second distance detecting module 1112 of the first social distancing device 11A sending a data packet to the second distance detecting module 1112 of the second social distancing device 11B and receives the data packet calculated by the second distance detecting module 1112 of the second social distancing device 11B to detect the distance, and recording the time information and the duration.

In summary, the social distancing device system can remind the user to maintain the social distance by the alarm module of the social distancing device, and calculate the exposure risk of the user according to the data sent by the social distancing device, thereby increasing the efficiency and reducing the infectivity. Moreover, the social distancing device system can calculate the exposure risk immediately and precisely by the learning module, thereby increasing the efficiency. In addition, the social distancing device system can switch the distance detecting modules to save the power and detect the distance precisely, thereby increasing the deficiency and reducing the cost.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A social distancing device system, comprising:
a first social distancing device, further comprising:
a distance detecting module, configured to detect a distance between the first social distancing device and a second social distancing device;
a processor, coupled to the distance detecting module and configured to record a time information and a duration when the first social distancing device communicates with the second social distancing device; and
a transmission module, coupled to the processor and controlled by the processor to transmit a signal comprising the distance, the time information and the duration; and
a computing device, configured to receive the distance, the time information and duration from the transmission module, the computing device further comprising:
a database, configured to store the distance, the time information and the duration; and
a computing module, coupled to the database to calculate an exposure risk of the first social distancing device according to the distance, the time information and the duration.

2. The system of claim 1, wherein the distance detecting module comprises at least one wireless signal transceiver for communicating with the distance detecting module in the second social distancing device and detecting the distance by signal strength.

3. The system of claim 3, wherein the at least one wireless signal transceiver is one selected from Wi-Fi transceiver, Bluetooth transceiver, NFC transceiver and UWB transceiver.

4. The system of claim 1, wherein the distance detecting module is a GPS module for detecting the distance between the first social distancing device and the second social distancing device by GPS locating.

5. The system of claim 1, wherein the first social distancing device further comprises an alarm module to generate a first alarm signal when the distance detected by the distance detecting module is less than a predetermined distance.

6. The system of claim 5, wherein the predetermined distance is six feet.

7. The system of claim 1, wherein the computing device sends a second alarm signal to the first social distancing device according to the exposure risk calculated by the computing processor.

8. The system of claim 1, wherein the database is configured to store a data of the user of the second social distancing device, and the computing module calculates the exposure risk according to the distance, the time information, the duration and the data of the user of the second social distancing device.

9. The system of claim 8, wherein the computing device further comprises a learning module coupled to the database and the computing module, the learning module generates an exposure risk model according to the distance, the time information, the duration and the data stored in the database by machine learning, and the computing module analyzes the distance, the time information, the duration and the data by the exposure risk model to generate the exposure risk.

10. A social distancing device, comprising:
a first distance detecting module, configured to communicate with another social distancing device in an area with a radius;
a second distance detecting module, configured to detect a distance between the social distancing device and the another social distancing device;
a processor, coupled to the first distance detecting module and the second distance detecting module and configured to record a time information and a duration when the first social distancing device communicates with the another social distancing device; and
a transmission module, coupled to the processor and controlled by the processor to transmit a signal of the distance, the time information and the duration to a server;
wherein, the processor controls the second distance detecting module to detect the distance after the first distance detecting module communicates with the another social distancing device.

11. The social distancing device of claim 10, wherein the second distance detecting module is configured to send and receive a data packet, the second distance detecting module sends the data packet to the another social distancing device and receives the data packet calculated by the another social distancing device to detect the distance.

12. The social distancing device of claim 10, further comprising an alarm module to generate a first alarm signal when the distance detected by the another distance detecting module is less than a predetermined distance.

13. The social distancing device of claim 12, wherein the predetermined distance is six feet.

14. A social distancing method, comprising the following steps of:
a first social distancing device communicating with a second social distancing device;
the first social distancing device detecting a distance between itself and the second social distancing device, and recording a time information and a duration;
the first social distancing device sending the distance, the time information and a duration to a computing device; and
the computing device calculating an exposure risk of the first social distancing device according to the distance, the time information and the duration.

15. The method of claim 14, wherein the step of the first social distancing device communicating with the second social distancing device further comprises the following steps of:
the first social distancing device searching another social distancing device in an area with a radius; and
the first social distancing device communicating with the second social distancing device when the second social distancing device is located in the area.

16. The method of claim 14, further comprising the following step:
the first social distancing device generating a first alarm signal when the distance is less than a predetermined distance.

17. The method of claim 14, wherein the step of the computing device calculating the exposure risk of the first social distancing device according to the distance, the time information and the duration further comprises the following step of:
the computing device calculating the exposure risk of the first social distancing device according to the distance, the time information, the duration and a data of the user of the second social distancing device stored in a database.

18. The method of claim 14, wherein the step of the computing device calculating the exposure risk of the first social distancing device according to the distance, the time information and the duration further comprises the following steps of:
generating an exposure risk model according to the distance, the time information, the duration and a data stored of the user of the second social distancing device stored in a database by machine learning; and
the computing module analyzing the distance, the time information, the duration and the data by the exposure risk model to generate the exposure risk.

19. The social method of claim 14, further comprising the following step:
the computing device sending a second alarm signal according to the exposure risk.

20. The method of claim 14, wherein the step of the first social distancing device detecting the distance between itself and the second social distancing device, and recording the time information and the duration further comprises the following step of:
the first social distancing device sending a data packet to the second social distancing device and receives the data packet calculated by the second social distancing device to detect the distance, and recording the time information and the duration.
